(19) United States
(12) Patent Application Publication
(10) Pub. No.: US 2004/0023098 A1
(43) Pub. Date: Feb. 5, 2004

(54) Compact electric apparatus

(75) Inventors: Shoji Nawa, Inuyama (JP); Eiji Kato, Inuyama (JP); Yasuo Ido, Inuyama (JP)

Correspondence Address: BROWDY AND NEIMARK, P.L.L.C., 624 NINTH STREET, NW, SUITE 300, WASHINGTON, DC, 20001-5303, US

(73) Assignee: Daido Metal Company, LTD., Nagoya (JP)

(21) Appl. No.: 10/463,394

(22) Filed: Jun. 18, 2003

(30) Foreign Application Priority Data
Aug. 2, 2002 (JP) 2002-226380

(51) Int. Cl. H01M 8/02

(52) U.S. Cl. 429/34

(57) ABSTRACT

In a compact electric apparatus with a power consumption source, a fuel cell unit includes a fuel cell for generating an electric power to be consumed by the power consumption source, a fuel storage section which stores therein a fuel for the fuel cell and has a control valve to be operated to control a flow of the fuel, and a fuel supply pipe through which the fuel is supplied from the fuel storage section to the fuel cell, a housing case contains therein the fuel cell unit, the power consumption source is mounted on the housing case, and the housing case has an opening through which the control valve faces to an outside of the housing case.

### BACKGROUND OF THE INVENTION AND RELATED ART STATEMENT

The present invention relates to a compact electric apparatus in which a housing case contains a power consumption source that consumes electric power generated by a fuel cell.

As a power supply apparatus to be used in a compact electric apparatus with good portability, a primary battery such as a dry-cell battery, and a secondary battery such as a rechargeable battery are generally used. A primary battery is compact and lightweight, and has therefore good portability. On the other hand, a secondary battery is compact and lightweight and can be used repeatedly by recharging it electrically, and is therefore used in various compact electric apparatuses.

### OBJECT AND SUMMARY OF THE INVENTION

Although an increase of an amount of electric power for compact electric apparatuses becomes desired with technological progress in electric apparatuses in which a large amount of electric power was not required previously, it is difficult for a conventional primary battery to generate a desired amount of electric power. Although a secondary battery can generate the desired amount of electric power, the secondary battery is deteriorated by repeated use thereof, and moreover, there is a problem that it is difficult for the primary and secondary batteries to be treated for being disposed of. Under this situation, the applicant focuses attention on a fuel cell used for an electric vehicle or the like which requires the large amount of electric power. The electric power is generated in the fuel cell by a chemical reaction between hydrogen and oxygen and the fuel cell is hard to deteriorate unlike a conventional primary and secondary batteries, so that constant output is expected to be generated. The present invention has been implemented in view of the above-described circumstances and an object of the present invention is to provide a compact electric apparatus of good portability with the fuel cell of less deterioration.

In order to attain the above-described object, according to the present invention, a compact electric apparatus with a power consumption source, comprises, a fuel cell unit including a fuel cell capable of generating an electric power to be consumed by the power consumption source, a fuel storage section which is adapted to store therein a fuel for the fuel cell and has a control valve to be operated to control a flow of the fuel, and a fuel supply pipe through which the fuel is capable of being supplied from the fuel storage section to the fuel cell, and a housing case which contains therein the fuel cell unit, and on which the power consumption source is mounted, and the housing case has an opening through which the control valve is capable of facing to an outside of the housing case. Since the housing case has the opening through which the control valve to be operated to control the flow of the fuel is capable of facing to the outside of the housing case, the control valve can be operated from the outside of the housing case so that the compact electric apparatus in which the power consumption source that consumes electric power generated by the fuel cell is mounted on the housing case can be easily operated.

Furthermore, if the fuel cell includes a purge valve to be operated to remove impurity from an inside of the fuel cell and the housing case has another opening through which the purge valve is capable of facing to the outside of the housing case, the purge valve for removing the impurity from the inside the fuel cell can be operated without opening the housing case so that the compact electric apparatus in which the power consumption source that consumes electric power generated by the fuel cell is mounted on the housing case can be easily operated.

Furthermore, if the housing case has an external terminal to be connected electrically to another compact electric apparatus, the electric power generated by the fuel cell in the compact electric apparatus can be used not only in the compact electric apparatus but also in the another compact electric apparatus through the external terminal.

### BRIEF DESCRIPTION OF THE DRAWINGS

FIG. 1 is an oblique projection view showing a hand light as an embodiment of the invention.

FIG. 2A is a plan view of the hand light.

FIG. 2B is a side view of the hand light.

FIG. 2C is a front view of the hand light.

FIG. 2D is a rear view of the hand light.

FIG. 3 is an exploded oblique projection view of the hand light.

FIG. 4 is a cross sectional view of the hand light.

FIG. 5 is an oblique projection view showing a fuel cell unit as the embodiment.

FIG. 6 is a wiring diagram of the hand light.

FIG. 7 is a cross sectional view showing a fuel cell as the embodiment.

FIG. 8 includes a front view and a sectional view showing a nut of the fuel cell as the embodiment.

### DETAILED DESCRIPTION OF THE PREFERRED EMBODIMENTS

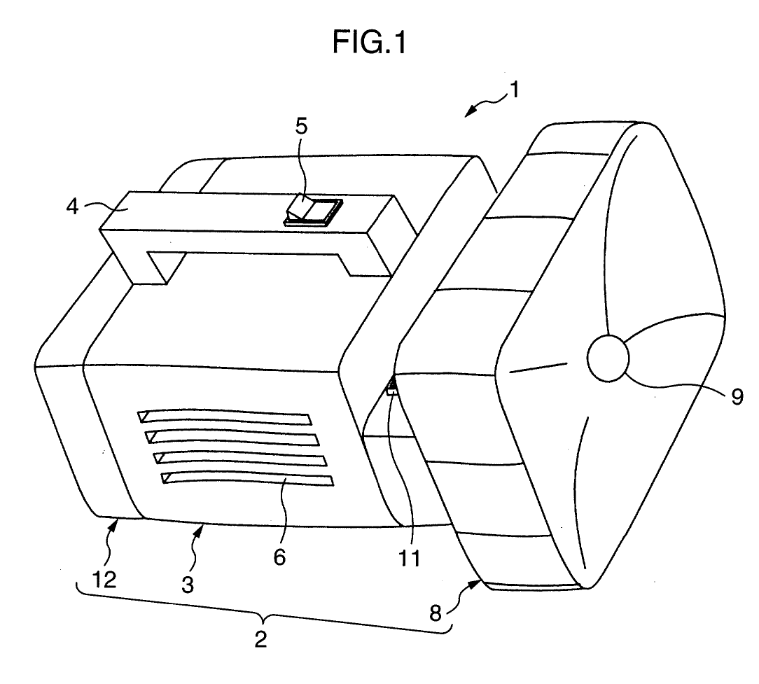

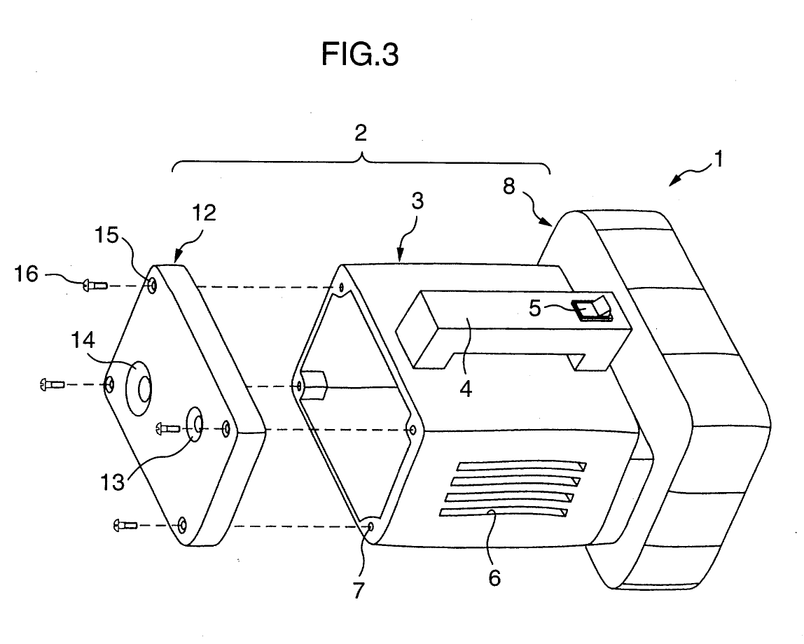

With reference to the attached drawings, a hand light 1 is explained as an embodiment of a compact electric apparatus of the present invention. Outer appearance of the hand light 1 is explained with reference to FIG. 1 to FIG. 3.

As shown in FIG. 1, in the hand light 1, a fuel cell unit 20 which will be described later is contained by a housing case 2, and the housing case 2 includes a housing section 3, a light-emitting section 8 provided on a front surface of the housing section 3 and an opening/closing cover 12 provided on a back surface of the housing section 3.

The light-emitting section 8 includes a light 9 which is a power consumption source to consume an electric power generated by a fuel cell 21 which will be described later, and a reflector 10 that reflects a light emitted from the light 9. Furthermore, in this embodiment, an external terminal 11 is provided on the light-emitting section 8 to be electrically connected through an electric wiring to another compact electric apparatus. The external terminal 11 will be described in detail later.

The housing section 3 has a handle 4 at an upper portion thereof and a power switch 5 for the light 9 on an upper surface of the handle 4. Furthermore, a vent 6 which will be described later is provided on a side of the housing section 3. Furthermore, screw holes 7 which will be described later are provided at an end of the housing section 3 facing to the opening/closing cover 12.

The opening/closing cover 12 is provided at a back portion of the housing section 3, and an opening 13 for a purge valve which will be described later, an opening 14 for a fuel supply control valve and screw holes 15 are provided on a surface of the opening/closing cover 12. Furthermore, the opening/closing cover 12 is mounted on the housing section 3 in such a manner that the opening/closing cover 12 can be opened and closed, by screws 16 which are screwed in the screw holes 7 of the housing section 3 through the screw holes 15 of the opening/closing cover 12.

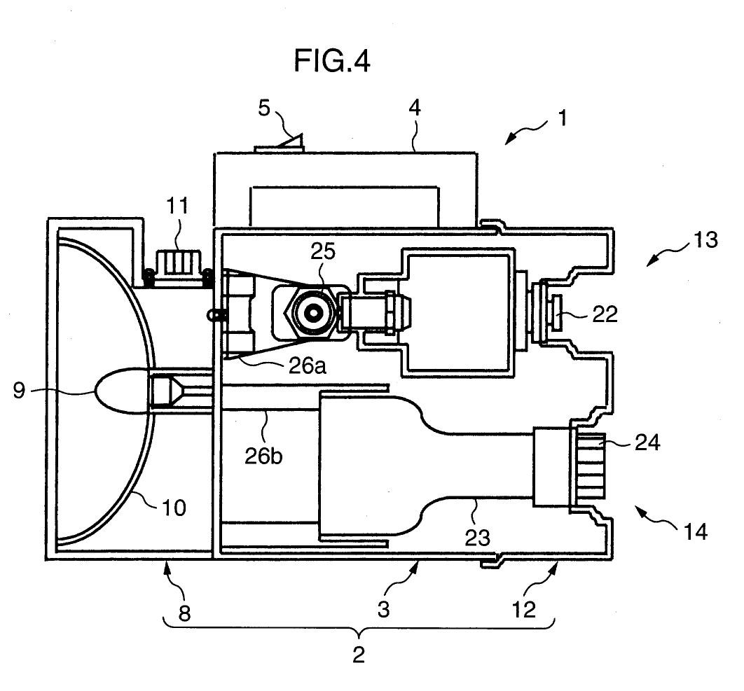

An inner structure of the housing case 2 will be explained with reference to FIG. 4. FIG. 4 is a cross sectional view of the hand light 1. As shown in FIG. 4, the housing section 3 incorporates a fuel cell unit 20 including a fuel cell 21, a fuel tank 23 as a fuel storage section which stores the fuel for the fuel cell and is provided with a fuel supply control valve 24 as a control valve to be operated to supply or stop the fuel, a fuel supply pipe 25 for supplying the fuel from the fuel tank 23 to the fuel cell 21 and a pressure regulating valve 27, and the fuel cell 21 is provided with a purge valve 22 for removing an impurity (e.g., air trapped in a fuel supply path around a tie bolt 38 which will be described later) from an inside of the fuel cell 21. Incidentally, the pressure regulating valve 27 is provided just before the fuel cell 21 to keep the pressure of hydrogen to be supplied to the fuel cell 21 constant.

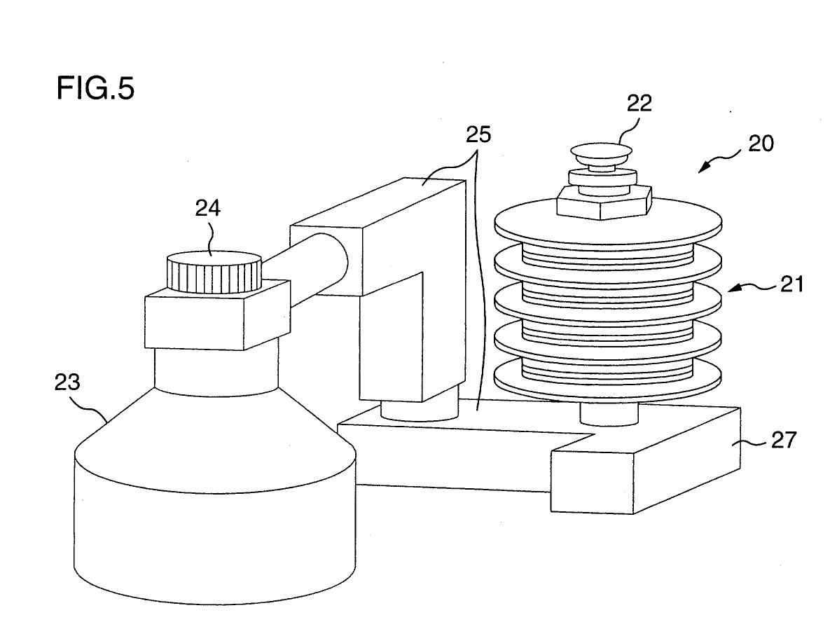

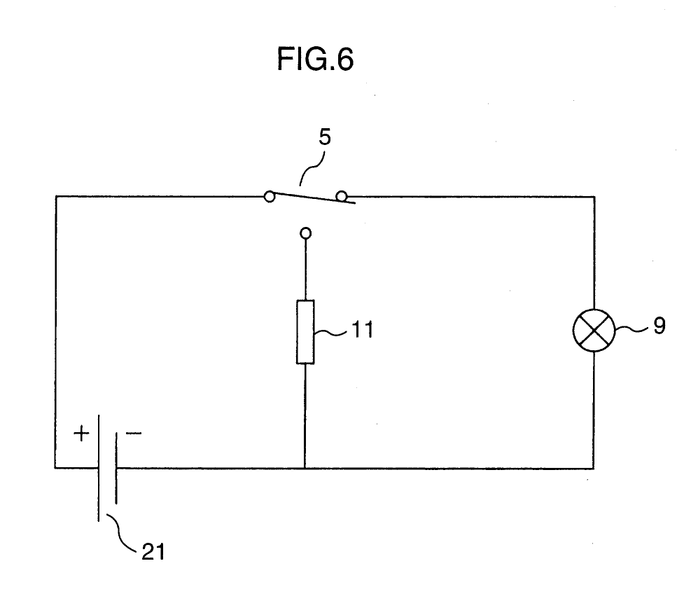

First, the fuel cell unit 20 will be explained with reference to FIG. 4 to FIG. 6. FIG. 5 is an oblique projection view of the fuel cell unit 20 and FIG. 6 is a wiring diagram of the hand light 1. As shown in FIG. 5, the fuel cell unit 20 includes the aforementioned fuel cell 21, fuel tank 23 and fuel supply pipe 25 connecting fluidly the fuel tank 23 and fuel cell 21 to each other. Furthermore, the fuel cell unit 20 is fixed to an inside of the housing section 3 by means of holders 26a and 26b as shown in FIG. 4. The fuel cell 21 generally uses hydrogen as a main fuel to take out an energy produced by a chemical reaction between hydrogen and oxygen. In the following embodiments, the fuel is mainly hydrogen, and oxygen is obtainable from the air to be transferred.

Here, a method for electric power generation by the fuel cell unit 20 will be explained briefly. First, the hydrogen as the fuel needs to be supplied from the fuel tank 23 to the fuel cell 21 with regulating the fuel supply control valve 24, and since the fuel of the fuel cell 21 to be used in this embodiment is pure hydrogen, it is necessary to remove the impurity (e.g., the air) other than hydrogen from the inside of the fuel cell 21. Thus, immediately after the fuel supply control valve 24 is opened, the purge valve 22 is pressed to discharge the air in the fuel cell 21 to an outside of the fuel cell 21. Then, when the fuel supply control valve 24 is opened, the hydrogen is supplied to the fuel cell 21 to react with the oxygen so that the electric power is generated. With the electric power generation, the water is produced and a heat energy is generated. As stated above, the oxygen to be used is supplied from the air. The water produced with the electric power generation is evaporated by the generated heat energy and discharge to the atmosphere. For this effect, in this embodiment, the housing case 2 has a specific structure suitable for the compact electric apparatus incorporating the fuel cell 21. The housing section 3 of the aforementioned housing case 2 is provided with a vent 6 through which the oxygen is taken in and the vapor produced with the electric power generation is discharged from the housing case 2.

Furthermore, when the fuel supply control valve 24 provided in the fuel tank 23 of the fuel cell unit 20 is opened, the hydrogen is supplied to the fuel cell 21 to generate the electric power, so that the light 9 emits light when the power switch 5 provided in the handle 4 at the top of the housing section 3 is turned on. On the other hand, when the fuel supply control valve 24 is closed, the hydrogen is prevented from being supplied to the fuel cell 21, the electric power generation is stopped and the light 9 dose not emit the light even when the power switch 5 is turned on. However, since the external terminal 11 provided at the upper portion of the light-emitting section 8 is not electrically connected to the power switch 5 as shown in FIG. 6, it is not possible to electrically charge another compact electric apparatus even when the fuel supply control valve 24 is opened. Incidentally, when the power switch 5 is electrically connected to the external terminal 11, the another compact electric apparatus can be electrically charged through the external terminal 11.

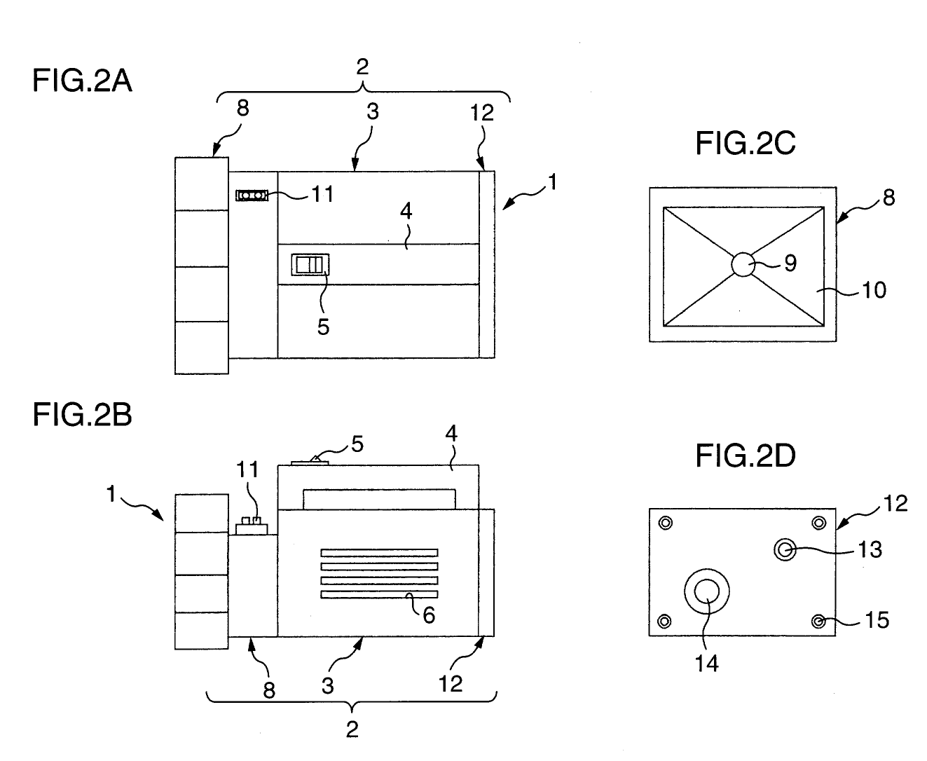

In this embodiment, a distinctive feature is shown in the housing case 2 of the hand light 1 in which the fuel cell unit 20 of the above-described structure is arranged. The housing case 2 incorporates, as shown in FIG. 4, the fuel cell unit 20 including the fuel cell 21, the fuel tank 23 as the fuel storage section which stores the fuel for the fuel cell 21 and is provided with the fuel supply control valve 24 as a control valve to be operated to supply the fuel, and the fuel supply pipe 25 through which the fuel is supplied from the fuel tank 23 to the fuel cell 21, and the opening/closing cover 12 of the housing case 2 is provided with an opening 14 through which the fuel supply control valve 24 faces to the outside of the housing case 2 as shown in FIG. 2. Furthermore, the opening/closing cover 12 of the housing case 2 is also provided with the opening 13 through which the purge valve 22 to be operated to remove the impurity from the inside of the fuel cell 21 faces to the outside of the housing case 2. The opening 14 for the fuel supply control valve and the opening 13 for the purge valve both provided on the opening/closing cover 12 allow the fuel supply control valve 24 and purge valve 22 of the fuel cell unit 20 to protrude out of the housing case 2.

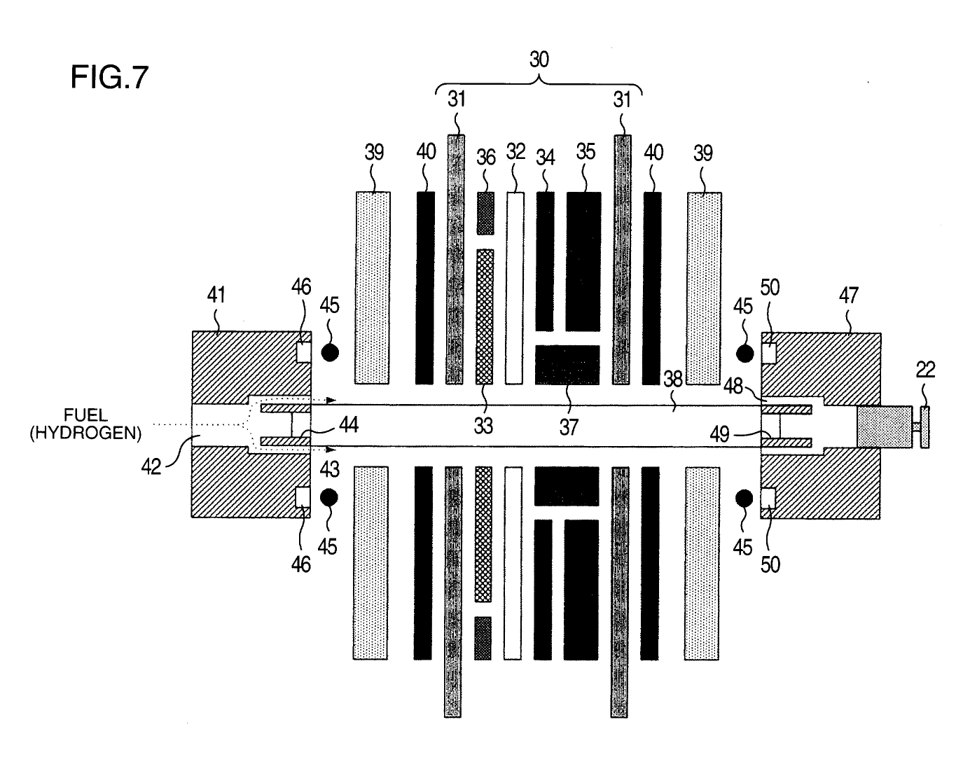

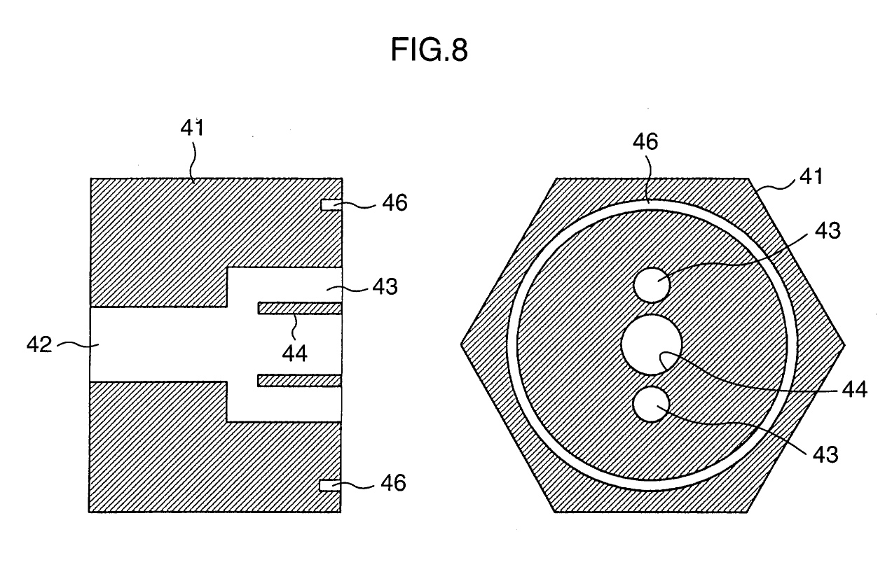

Furthermore, in this embodiment a polymer electrolyte fuel cell is used as the fuel cell, and this polymer fuel cell has a low operating temperature and a high output density. The polymer electrolyte fuel cell to be used in this embodiment will be explained with reference to FIG. 7 and FIG. 8. FIG. 7 is a cross sectional view of the fuel cell 21 and FIG. 8 includes front and side cross sectional views of a nut 41 of the fuel cell 21.

As shown in FIG. 7, the polymer electrolyte fuel cell includes a unit cell 30 between stainless steel separators 31 having a diameter larger than other components and a thickness of 0.3 mm, the unit cell 30 including a polymer electrolyte film 32 made of a perfluoro carbon sulfonate polymer member of 0.05 mm in thickness, with on both sides of this polymer electrolyte film 32, an oxygen electrode 34 of 0.5 mm in thickness made of a carbon sheet element, an oxygen channel plate 35 made of a carbon member of 3.5 mm in thickness placed at an outside of this oxygen electrode 34, an annular outer seal 36 of 2 mm in width made of synthetic rubber such as EPDM for sealing an outer peripheral portion of the fuel electrode 33, and an inner seal 37 made of synthetic rubber such as EPDM of 5 mm in width for sealing inner peripheral portions of the oxygen electrode 34 and oxygen channel plate 35. Furthermore, the fuel electrode 33 and the oxygen electrode 34 arranged respectively at the sides of the polymer electrolyte film 32 are coated with a catalyst for the chemical reaction.

The above-described unit cells 30 are stacked to have a number of the stacked unit cells 30 corresponding to a required output power, and in order to unite these stacked unit cells 30, a tie bolt 38 extends through an opening formed in central sections of these components. Furthermore, an end gasket 40 made of synthetic rubber such as EPDM is arranged between the separator plate 31 and an end plate 39 at each of outermost sides of the unit cell 30 and a plurality of the unit cells 30 are fixed to each other to be united in one piece by screwing stainless steel nuts 41 and 47 respectively on threaded portions of the tie bolt 38 at ends thereof to be pressed against the end plates 39, 39 made of epoxy resin.

As shown in FIG. 8, one of the nuts 41 for uniting these unit cells 30 in one piece, has a hole 42 at a center and an inside screw 44 is threaded from one end of the hole 42 to almost an axial center thereof, so that the tie bolt 38 can be screwed into the hole 42, and at least two fuel channels 43 are provided at outside of the inside screw 44 and extends to the hole 42. Moreover, a circular groove 46 is formed on a surface of the one of the nuts 41 adapted to contact the end plate 39 so that an O-ring 45 is fitted in the circular groove 46.

Furthermore, as shown in FIG. 7, another of the nuts 47 has an inside screw 49 threaded from one end of the another of the nuts 47 to almost an axial center thereof similarly to the one of the nuts 41 so that the threaded portion at the end of the tie bolt 38 is screwed into the another of the nuts 47 and a supply/exhaust port 48 is formed at a radial outside of the inside screw 49. Onto an axially opposite side of the inside screw 49, the purge valve 22 is attached for removing the impurity from the inside of the fuel cell and the impurity can be removed through the supply/exhaust port 48. A circular groove 50 is formed on a surface of the another of the nuts 47 adapted to contact the end plate 39 so that an O-ring 45 is fitted in the circular groove 50.

The portable fuel cell of the above-described configuration can be assembled as follows.

First, the one of the nuts 41 is attached to one end of the tie bolt 38 to form a central shaft of the fuel cell. The end plate 39 for the outermost side and the end gasket 40 are penetrated by the central shaft of the fuel cell through the central holes thereof, and in order to form the unit cell 30, the separator plate 31, fuel electrode 33, outer seal 36 located at a radial outside of the fuel electrode 33, polymer electrolyte film 32, inner seal 37, oxygen electrode 34 located at a radial outside of the inner seal 37, oxygen channel plate 35 located at the radial outside of the inner seal 37 and separator plate 31 are penetrated by the central shaft of the fuel cell through their central holes to be stacked so that the unit cell is assembled.

Subsequently, in order to form next one of the unit cell 30, onto the finally stacked separator plate 31 of the previously formed unit cell 30, similarly to the previously formed unit cell 30, the fuel electrode 33, outer seal 36 located at the radial outside of the fuel electrode 33, polymer electrolyte film 32, inner seal 37, oxygen electrode 34 located at the radial outside of the inner seal 37, oxygen channel plate 35 located at the radial outside of the inner seal 37 and separator plate 31 are penetrated by the central shaft of the fuel cell through their central holes to be stacked so that the unit cell is assembled. These unit cells 30 are stacked repeatedly to have a number of the stacked unit cells 30 corresponding to a required output power.

Finally, the end gasket 40 is arranged between the separator plate 31 of the outermost unit cell 30 and the end plate 39 while the central shaft extends through their center holes to stack them. This stack of the unit cells 30 is pressed with a predetermined pressing force of, for example, approximately 15 MPa. In this condition, the another of the nuts 47 provided with the purge valve 22 is screwed in the threaded portion at the end of the tie bolt 38 of the central shaft so that the whole stack is clamped with a predetermined torque of, for example, 6.8 Nm.

Furthermore, no housing case, etc., is used at a radial outside of the portable fuel cell as constructed above so that the portable fuel cell is exposed to the atmosphere. Therefore, the oxygen (air) for the fuel can be easily taken in. The water produced with the electric power generation moves radially outward on the fuel cell and is evaporated by the heat energy generated with the electric power generation to be discharged into the atmosphere.

A tube, etc., is further connected to the one of the nuts 41 of the fuel cell assembled as described above so that the fuel is supplied from a hydrogen generator, etc. to the fuel cell as the portable fuel cell. The fuel such as the hydrogen passes through the hole 42 and fuel channel 43 serving as a fuel supply port of the one of the nuts 41 to be to the inner end of the fuel electrode 33 of each of the unit cells 30 along the tie bolt 38. Since the fuel electrode 33 is made of a sheet of porous carbon, the fuel can be transferred radially through pores of the sheet of carbon without an excessive fuel channel plate, and can be directed to the polymer electrolyte film 32 by the outer seal 36 sealing a radially outer periphery of the fuel electrode 33. The oxygen electrode 34 and oxygen channel plate 35 are provided on a side of this polymer electrolyte film 32 opposite to the fuel electrode 33, so that the air is supplied through pores of a porous material forming the oxygen channel plate 35 to the oxygen electrode 34 from an outside thereof and the oxygen in the air is supplied to the oxygen electrode 34.

In this way, the oxygen and the hydrogen as the fuel supplied to respective sides of the polymer electrolyte film 32 chemically react with each other at the polymer electrolyte film 32 so that the electric power is generated between the fuel electrode as an anode and the oxygen electrode acting as a cathode. With the reaction between the hydrogen and oxygen, the water and heat energy are produced, while the water is evaporated by the generated heat energy to be discharged to the atmosphere. Furthermore, since the separator plate 31 has a radius larger than other components, a portion of the separator plate 31 protruding from the other components can be used as a radiator fin for radiating the generated heat energy.

The structure and operation of the hand light as the embodiment have been explained above. In this embodiment, the compact electric apparatus (hand light 1) includes the power consumption source (light 9) that consumes the electric power generated by the fuel cell 21 and the housing case 2 incorporating the power consumption source, the above-described housing case 2 incorporates the fuel cell unit 20 including the above-described fuel cell 21, the above-described fuel storage section 23 which stores the fuel for the above-described fuel cell 21 and is provided with the control valve 24 to be operated to supply the fuel, and the fuel supply pipe 25 that supplies the fuel from the above-described fuel storage section 23 to the above-described fuel cell 21, and the opening 14 is formed on the housing case 2 to expose the above-described control valve 24 through the opening 14 to the outside of the housing case 2 so that the control valve 24 operated to supply the fuel to the fuel cell 21 can be operated from outside of the housing case 2, and the compact electric apparatus 1 having in the housing case 2 the power consumption source 9 that consumes the electric power generated by the fuel cell 21 can be operated easily.

Furthermore, in this embodiment, the above-described fuel cell 21 is provided with the purge valve 22 which is operated to remove the impurity from the inside of the fuel cell, and the above-described housing case 2 is also provided with the opening 13 to expose the above-described purge valve 22 through the opening 13 to the outside of the housing case 2. By this configuration, since the opening 13 is formed in such a manner that the purge valve 22 for removing the impurity from the inside of the fuel cell 21 is exposed to the outside of the housing case 2, the purge valve 22 can be operated without opening the housing case 2 and the compact electric apparatus 1 having in the housing case 2 the power consumption source 9 that consumes the electric power generated by the fuel cell 21 can be operated easily.

Furthermore, in this embodiment, the above-described housing case 2 is provided with the external terminal 11 to be electrically connected to the wiring extending from another compact electric apparatus. By this configuration, the external terminal 11 for electrically connecting the fuel cell 21 to the another compact electric apparatus enables the electric power generated by the fuel cell 21 to be supplied not only to the compact electric apparatus including the fuel cell 21 but also to the another compact electric apparatus through the external terminal 11.

By the way, dimensions of the components of this embodiment should not be limited to the above-described ones, and they are just examples and can be determined according to the purpose of use and output required.

Furthermore, the opening 13 for the purge valve and the opening 14 for the fuel supply control valve in this embodiment may be provided on another position, for example, the top surface of the housing section 3 other than the end of the hand light 1 at the side opposite to the light-emitting section 8.

Furthermore, the opening/closing cover 12 is fixed by the screws 16 in this embodiment, but the opening/closing cover 12 may be fixed by another structure, for example, a pair of a stopper piece and a stopper hole so that the opening/closing cover 12 can be freely opened and closed.

Furthermore, the external terminal 11 is provided on the top surface of the light-emitting section 8 in this embodiment, but the external terminal 11 may be arranged at another position, for example, the top surface or side surface of the housing section 3 of the housing case 2.

Furthermore, this embodiment of the compact electric apparatus is the hand light 1, but the present invention is applicable to another embodiment of compact electric apparatus provided with another power consumption source for consuming the electric power generated by the fuel cell 21, for example, a portable radio incorporating the fuel cell 21.

As is apparent from the above explanations, the invention according to a first aspect allows the control valve operated to supply fuel to the fuel cell to have access to the outside from the housing case, which makes it possible to operate the control valve from outside the housing case and simplify operation of the compact electric apparatus with the power consumption source that consumes electric power generated by the fuel cell placed in the housing case.

Furthermore, the invention according to a second aspect forms an opening that allows the purge valve for removing impurities inside the fuel cell to have access to the outside, which makes it possible to operate the purge valve without opening the housing case and simplify operation of the compact electric apparatus with the power consumption source that consumes electric power generated by the fuel cell placed in the housing case.

Furthermore, the invention according to a third aspect provides an external terminal allowing connections of the fuel cell with another compact electric apparatus, which makes it possible to use the apparatus not only as the own power supply apparatus using the electric power generated by the fuel cell but also as the power supply apparatus for another compact electric apparatus through the external terminal.

What is claimed is:

1. A compact electric apparatus with a power consumption source, comprising,
a fuel cell unit including a fuel cell capable of generating an electric power to be consumed by the power consumption source, a fuel storage section which is adapted to store therein a fuel for the fuel cell and has a control valve to be operated to control a flow of the fuel, and a fuel supply pipe through which the fuel is capable of being supplied from the fuel storage section to the fuel cell, and
a housing case which contains therein the fuel cell unit, and on which the power consumption source is mounted,
wherein the housing case has an opening through which the control valve is capable of facing to an outside of the housing case.

2. A compact electric apparatus according to claim 1,
wherein the fuel cell includes a purge valve to be operated to remove impurity from an inside of the fuel cell, and
the housing case has another opening through which the purge valve is capable of facing to the outside of the housing case.

3. A compact electric apparatus according to claim 1,
wherein the housing case has an external terminal to be connected electrically to another compact electric apparatus.

4. A compact electric apparatus according to claim 2,
wherein the housing case has an external terminal to be connected electrically to another compact electric apparatus.
